(19) United States
(12) Patent Application Publication
(10) Pub. No.: US 2007/0242335 A1
(43) Pub. Date: Oct. 18, 2007

(54) Translational filter, shutter, aperture apparatus for selecting and combining filtered and unfiltered light

(76) Inventors: Thomas A. Hasling, Columbus, GA (US); Vitaly Vodyanoy, Auburn, AL (US); Oleg Pustovyy, Auburn, AL (US)

Correspondence Address: HAVERSTOCK & OWENS LLP, 162 N WOLFE ROAD, SUNNYVALE, CA, 94086, US

(21) Appl. No.: 11/708,877

(22) Filed: Feb. 20, 2007

Related U.S. Application Data
(60) Provisional application No. 60/775,659, filed on Feb. 20, 2006.

(51) Int. Cl. G02B 26/02

(52) U.S. Cl. 359/230; 359/233

(57) ABSTRACT

A method and apparatus for filtering and mixing light is provided. The apparatus comprises a translational filter, aperture and shutter. A light beam and the translational filter, aperture and shutter are moved relative to each other to precisely control the proportions of filtered, unobstructed and blocked light. A method for precisely controlling the proportions of filtered, unobstructed and blocked light is also provided. Optional accessories include additional translational filters, apertures and shutters, light guides, relay lenses, microscopes, computers, motors for controlling the positions of the components, focusing lenses, and mechanical shutters.

### RELATED APPLICATIONS

The present application claims priority to U.S. Provisional Patent Application No. 60/775,659, filed on Feb. 20, 2006, and entitled “Translational filter, shutter, aperture apparatus for selecting and combining filtered and unfiltered light” to the same inventors under U.S.C. section 119(e). This application incorporates U.S. Provisional Patent Application No. 60/775,659, filed on Feb. 20, 2006, and entitled “Translational filter, shutter, aperture apparatus for selecting and combining filtered and unfiltered light” to the same inventors by reference in its entirety.

### FIELD OF THE INVENTION

The present invention relates generally to the field of mixing light for optical applications. More particularly, the invention relates to applications for mixing and combining light utilizing a translational filter, shutter, aperture apparatus.

### BACKGROUND

Many applications exist which require light to be filtered and mixed. For example, traditional microscopy and macroscopy techniques often times use a combination of light to enhance the views and images seen by such apparatuses. Traditional brightfield microscopy, fluorescent microscopy, darkfield microscopy and applications in macroscopy are examples of such techniques which benefit from using mixed filtered light.

Brightfield microscopy is a simple microscopy technique which involves shining light on a sample, allowing the light to interact with the sample and gathering the resulting light in an objective lens. Differences in refractive index and opacity within the sample cause an image of that sample to be seen in the objective lens.

Fluorescent microscopy developed as a technique to take advantage of the fact that certain compounds fluoresce when exposed to light having a particular wavelength. Fluorescent microscopes can be useful to the study of bacteria, animal, and plant cells, as they show primary fluorescence (autofluorescence) when illuminated with ultraviolet light or specific flourescence when combined with antibiotics or dyes. Such microscopes bombard a sample with photons having an excitation frequency which matches the frequency that produces fluorescence in that particular sample. The sample then emits light which normally has a longer wavelength than that of the exciting light. Three important steps can divide the process of fluorescence. First, a molecule is excited by an incoming photon during the first few femtoseconds. During the next few picoseconds, the molecule goes through a vibrational relaxation of an excited state electron to the lowest energy level of the intermediate states. Finally, emission of a longer wavelength photon and recovery of the molecule into the ground state occurs during a few nanoseconds. The whole process from excitation of the molecule by an excitation light (EL) to emission of a longer wavelength fluorescent light (FL) is used for fluorescent microscopy.

The main function of a fluorescent microscope is to illuminate a sample with light of a specific wavelength (excitation light), excite the molecules of the sample with a fluorescent light, and then separate a weak emitted fluorescence from the excitation light, so that the emitted fluorescence can be observed.

The light of the wavelengths required for fluorescence excitation are traditionally selected by a single excitation filter, which transmits only exciting light and suppresses light of all other wavelengths. A certain part of the exciting light is adsorbed by the sample and almost instantaneously re-emitted at longer wavelengths as fluorescence light. A barrier filter transmits the fluorescence light (emission light). The rest of the excitation light which passes through or reflects from the sample is absorbed by the barrier filter. As a result, a color image of the sample is observed (or recorded) against a dark background.

Early fluorescence microscopes were generally brightfield transmitted light microscopes equipped with excitation and barrier filters. Brightfield microscopy involves shining incident light directly onto a sample.

Darkfield microscopy is another technique used to increase the contrast in the images of a certain sample. The darkfield technique utilizes a darkfield condenser which takes in light from a light source and projects the light out at oblique angles. This results in a hollow inverted cone of light whose tip passes through the sample, but which diverges such that the incident light does not enter the objective lens of the microscope. This results in an image which appears bright against a dark background.

A number of problems exist in these techniques. First, when using a brightfield, darkfield or interference techniques, the full-spectrum light typically over shines any fluorescence emitted by the sample.

Next, when using a filter for fluorescence microscopy, the filter can either be ‘on’ of ‘off’ as a filter is physically inserted or removed from an optical train. This limitation often times restricts a scientist's ability to simultaneously observe all parts of a sample, both the parts with a fluorescent tag and those without such a tag. For example, a scientist wishing to view the nucleus of a particular cell may use a blue filter to observe a cell whose nucleus fluoresces green with blue light. However, blue light illuminating the other parts of the cell is blocked by the emission filter. Therefore, the scientist can either choose to view the nucleus or the surrounding cellular features, but not both simultaneously.

Macroscopy, similar to microscopy, can use flourescent, darkfield or brightfield techniques to observe larger objects, such as whole organisms or tissues. However, the current state of microscopy and macroscopy requires a scientist to take a number of still shots of an object at different frequencies and overlay the still images in order to get a full image.

### SUMMARY OF THE INVENTION

The present invention provides a method and discloses an apparatus for mixing light. In some aspects of the invention a translational filter, aperture and shutter apparatus are able to filter some portion of light, block some portion of light and allow some portion of light to pass through unobstructed. The proportions of this light are controllable. Furthermore, the light is able to be combined. In some embodiments, the shutter apparatus is not required.

In some embodiments, a single filter, aperture shutter is used. In other embodiments multiple filters, apertures and shutters are used. In some embodiments, the filters, apertures and shutters are positioned along the outside ring of a disk. In other embodiments, the filters, apertures and shutters are positioned on slides, matrixes, disks and the like.

In some embodiments, the translational filter, aperture and shutter apparatus is a stand-alone module device. While in other embodiments, the translational filter, aperture and shutter apparatus is integrated into a microscope or similar device using the mixed light. In some embodiments, the translational filter, aperture and shutter apparatus is controllable by a computer.

In some embodiments of the present invention, more than one translational filter, aperture and shutter apparatus is used to create a strobing effect. A method of observing samples in real time is disclosed and accomplished using the strobing effect.

Optional accessories which are able to be used with the translational filter, aperture and shutter apparatus include additional translational filters, apertures and shutters, light guides, relay lenses, microscopes, computers, motors for controlling the positions of the components, focusing lenses, and mechanical shutters.

### BRIEF DESCRIPTION OF THE DRAWINGS

The novel features of the invention are set forth in the appended claims. However, for the purpose of explanation, several embodiments of the invention are set forth in the following figures.

FIG. 1A illustrates a translational filter, aperture and shutter with a collimated light beam completely blocked by the shutter, according to some embodiments of the present invention.

FIG. 1B illustrates a translational filter, aperture and shutter with a collimated light beam partially filtered by the filter and partially blocked by the shutter, according to some embodiments of the present invention.

FIG. 1C illustrates a translational filter, aperture and shutter with a collimated light beam fully filtered by the filter, according to some embodiments of the present invention.

FIG. 1D illustrates a translational filter, aperture and shutter with a collimated light beam partially filtered by the filter and partially passed through the aperture, according to some embodiments of the present invention.

FIG. 1E illustrates a translational filter, aperture and shutter with a collimated light beam completely passed through the aperture, according to some embodiments of the present invention.

FIG. 1F illustrates a translational filter, aperture and shutter with a collimated light beam partially passed through the aperture and partially blocked by the shutter, according to some embodiments of the present invention.

FIG. 2A illustrates a relay system with a translational filter, aperture and shutter with a collimated light beam completely blocked by the shutter, according to some embodiments of the present invention.

FIG. 2B illustrates a relay system with a translational filter, aperture and shutter with a collimated light beam partially filtered by the filter and partially blocked by the shutter, according to some embodiments of the present invention.

FIG. 2C illustrates a relay system with a translational filter, aperture and shutter with a collimated light beam fully filtered by the filter, according to some embodiments of the present invention.

FIG. 2D illustrates a relay system with a translational filter, aperture and shutter with a collimated light beam partially filtered by the filter and partially passed through the aperture, according to some embodiments of the present invention.

FIG. 2E illustrates a relay system with a translational filter, aperture and shutter with a collimated light beam completely passed through the aperture, according to some embodiments of the present invention.

FIG. 2F illustrates a relay system with a translational filter, aperture and shutter with a collimated light beam partially passed through the aperture and partially blocked by the shutter, according to some embodiments of the present invention.

FIG. 3A illustrates a front view of a rotating translational filter, aperture and shutter with a collimated light beam completely blocked by the shutter, according to some embodiments of the present invention.

FIG. 3B illustrates a front view of a rotating translational filter, aperture and shutter with a collimated light beam partially filtered by the filter and partially blocked by the shutter, according to some embodiments of the present invention.

FIG. 3C illustrates a front view of a rotating translational filter, aperture and shutter with a collimated light beam fully filtered by the filter, according to some embodiments of the present invention.

FIG. 3D illustrates a front view of a rotating translational filter, aperture and shutter with a collimated light beam partially filtered by the filter and partially passed through the aperture, according to some embodiments of the present invention.

FIG. 3E illustrates a front view of a rotating translational filter, aperture and shutter with a collimated light beam completely passed through the aperture, according to some embodiments of the present invention.

FIG. 3F illustrates a front view of a rotating translational filter, aperture and shutter with a collimated light beam partially passed through the aperture and partially blocked by the shutter, according to some embodiments of the present invention.

FIG. 4A illustrates a perspective of a translational filter and aperture module with multiple filters and apertures according to some embodiments of the present invention.

FIG. 4B illustrates a front view of a rotatable strobing device including multiple filters, a clear aperture and corresponding shutters according to some embodiments of the present invention.

FIG. 5A illustrates a front view of a rotatable translational filter and aperture module according to some embodiments of the present invention.

FIG. 5B illustrates a side view of a rotatable translational filter and aperture module according to some embodiments of the present invention.

FIG. 6 illustrates a sliding translational filter and aperture module according to some embodiments of the present invention.

FIG. 7 illustrates a translational filter and aperture module with a matrix of openings for filters, apertures and shutters according to some embodiments of the present invention.

FIG. 8 illustrates multiple translational filters according to some embodiments of the present invention.

FIG. 9 illustrates the stand alone translational filter, aperture and shutter module coupled to a microscope and a computer according to some embodiments of the present invention.

### DETAILED DESCRIPTION

The present invention allows users, including researchers and scientists, to combine filtered and unfiltered light for producing fluorescent and full-spectrum images using filters with different spectral band passage, apertures and shutters. The proportions of wavelengths and their relative intensity are fine-tunable along with the relative intensity of wide spectrum light. The system of the present invention is also able to be used in devices that detect flourescent signals.

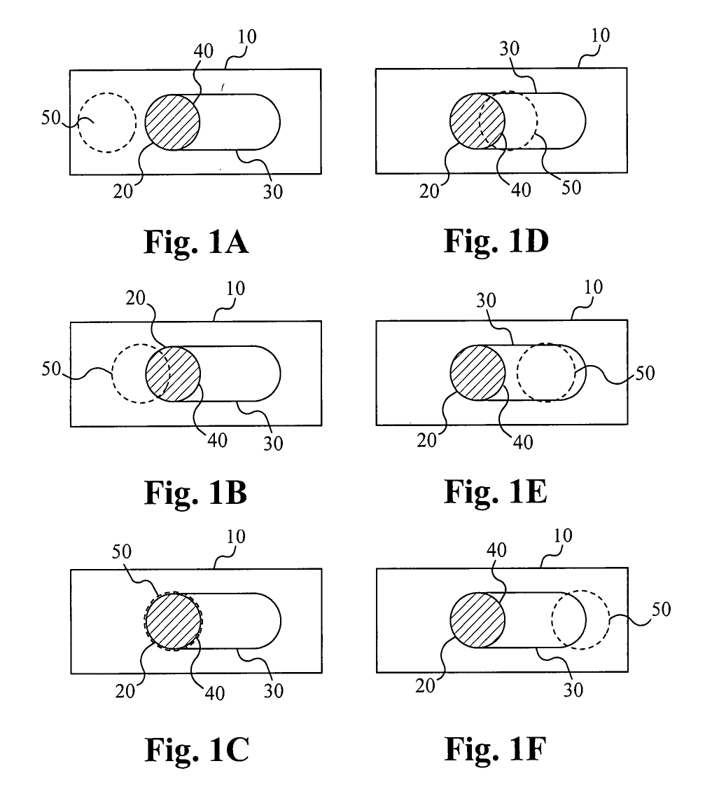

FIGS. 1A-1F illustrate one embodiment of the translational filter, aperture and shutter of the present invention. The embodiments shown in FIGS. 1A-1F include the movable filter module 10, a slot 20 for holding a filter 40, and an aperture 30 in different positions relative to a light beam 50. The movable filter module 10 is solid and acts like a shutter by blocking incident light. A collimated light beam 50 is directed perpendicular to the movable filter module 10. The movable filter module 10 is configured to filter, block, or allow all or any portion of the light from a light source to pass therethrough.

FIG. 1A shows the collimated light beam 50 blocked by the shutter (movable filter module 10). FIG. 1B shows the collimated light beam 50 partially filtered by the filter 40 and partially blocked by the shutter (movable filter module 10). FIG. 1C shows the collimated light beam 50 fully filtered by the filter 40. FIG. 1D shows the collimated light beam 50 partially filtered by the filter 40 and partially passed through the aperture 30. FIG. 1E shows the collimated light beam 50 completely passed through the aperture 30. FIG. 1F shows the collimated light beam 50 partially passed through the aperture 30 and partially blocked by the shutter (movable filter module 10).

To achieve the combinations of filtered and unfiltered light described herein, the position of the light beam 50 relative to the filter module 10, the filter 40 and the aperture 30 is changed. This is done by either moving the light beam 50 relative to the filter module 10, the filter 40 and the aperture 30, by moving the filter module 10, the filter 40 and the aperture 30 relative to the light beam 50, or some combination of the above.

It should be apparent to those skilled in the art that different configurations of the filter, aperture and shutter are possible, including configurations without a shutter and only a filter and aperture.

Another problem with traditional microscopy techniques for filtering light is filter degradation. It is common in the field of microscopy to use a small light guide to transfer light from a light source since light loss is minimized. For instance, a 3 millimeter optical guide may be utilized to transmit light. Common size optical filters are approximately 25 millimeters in diameter. Using the 3 millimeter optical guide with the 25 millimeter filter may eventually lead to degradation or breakage of the filter because all of the energy in the guide is applied to a tiny part of the filter. The energy degrades the coating on the filter or cracks the glass over time. Therefore, it is an object of the present invention to spread out the energy of a light source using a relay system of lenses to spread out the light's energy and prevent filter degradation and then refocus the light to be inserted into a light guide or system.

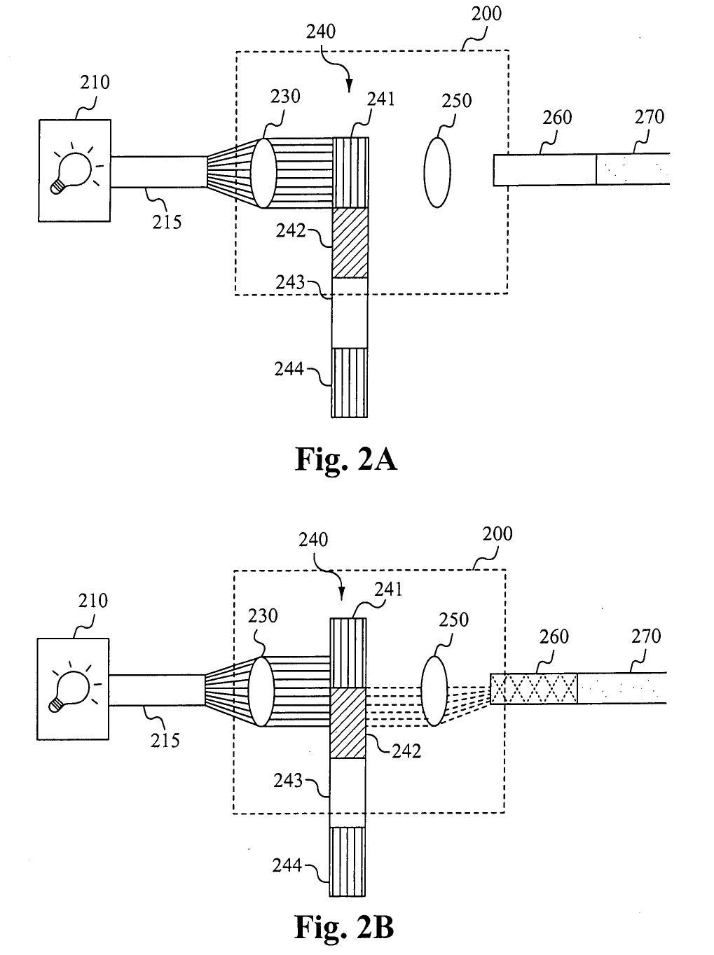

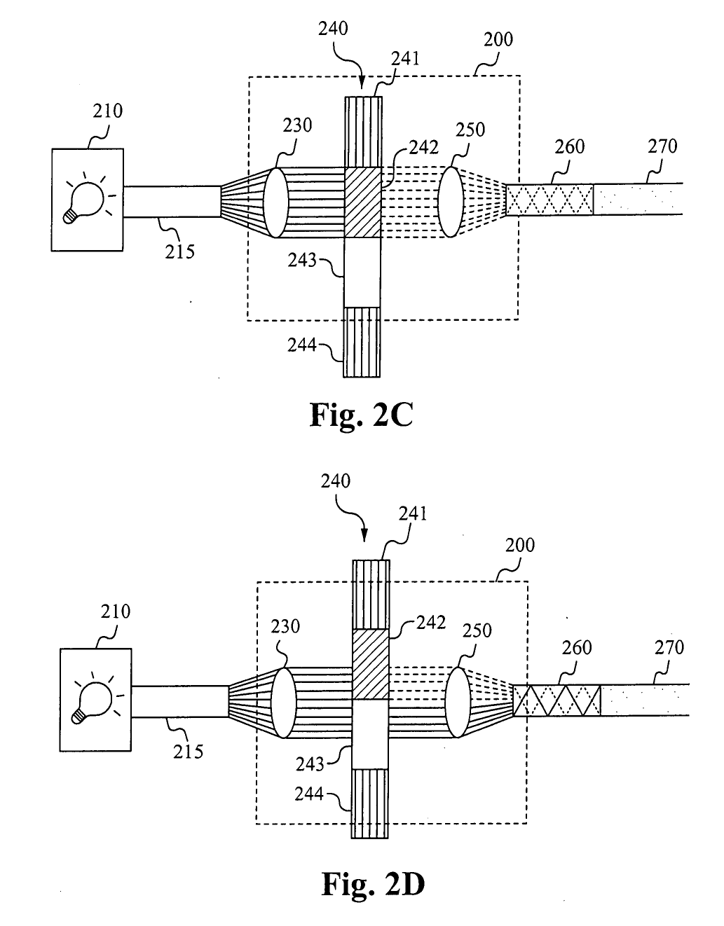

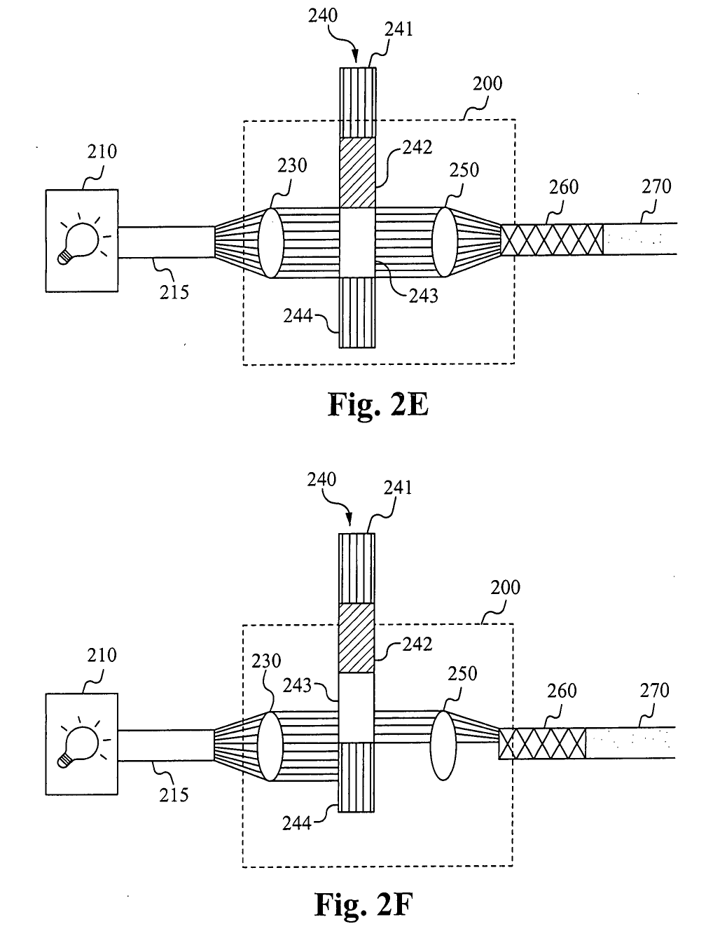

FIGS. 2A-2F illustrate a relay system according to some embodiments of the present invention, corresponding to the relative filter, aperture and shutter placements of FIGS. 1A-1F. FIGS. 2A-2F show a light source 210 and a light guide 215. In some embodiments, the light source 210 is a high-intensity discharge (HID) lamp such as Ceramic discharge metal halide lamps, Hydrargyrum medium-arc iodide (HMI) lamps, Mercury-vapor lamps, Metal halide lamps, Sodium vapor lamps or Xenon arc lamps. However, it will be apparent to those skilled in the art that any other appropriate light source is similarly envisioned. In some embodiments of the present invention, the light guide 215 is not included, but rather the light from the light source 210 is provided directly to the relay system 200.

Before being filtered, it is preferred that the light to be filtered first be collimated. In the relay system of FIGS. 2A-2F, the light is collimated by a collimating lens system 230. The collimating lens system 230 comprises either a single collimating lens or a series of collimating lenses. The light in the relay system 200 is directed towards the collimating lens system 230 which collimates the light such that it evenly makes contact with the surface of a movable filter module 240. The movable filter module 240 comprises a shutter portion 241, a filter 242, an aperture 243 and a shutter portion 244. The relay system 200 helps achieve important objects of the present invention including to prevent filter degradation by ensuring that incident light hits the filter module 240 evenly and to improve the precise movement of the filter, shutter and aperture relative to the collimated light beam. In this respect, it is easier to precisely align the filter, shutter and aperture if the light is expanded, filtered and then refocused. Preferably, the collimated light beam is expanded to match the size of the filter 242.

After passing through the filter module 240, the light is directed to a focusing lens system 250 and then focused into a light guide 260 at an output. The light guide 260 helps to achieve another important aspect of the present invention. The light guide 260 provides a surface geometry for internal reflection of the light. After the light enters the light guide 260, internal reflection mixes the light and the light exits the light guide 260 mixed as resultant light 270. For example, if 50% of the light entering the movable filter module 240 is filtered, resulting in a wavelength of 500 nanometers (green, visible), and 50% is unobstructed, the resulting light, after being mixed in the light guide 260 will be one-half green light and one-half full-spectrum light. Furthermore, the movable filter module 240 is movable, and therefore a user is able to fine-tune the component percentages of the light by moving the filter 242 in and out of the light beam. In other embodiments, the relay system 200 is moved relative to the filter module 240 thereby moving the light beam relative to the filter module 240. In some embodiments of the present invention, the light guide 260 is not included at the output, but rather the light from the focusing lens system 250 is provided directly to a device, system or other apparatus.

FIG. 2A shows the relay system 200 with the collimated light beam completely blocked by the shutter 241. FIG. 2B shows the relay system 200 with the collimated light beam partially filtered by the filter 242 and partially blocked by the shutter 241. FIG. 2C shows the relay system 200 with the collimated light beam fully filtered by the filter 242. FIG. 2D shows the relay system 200 with the collimated light beam partially filtered by the filter 242 and partially passed through the aperture 243. FIG. 2E shows the relay system 200 with the collimated light beam completely passed through the aperture 243. FIG. 2F shows the relay system 200 with the collimated light beam partially passed through the aperture 243 and partially blocked by the shutter 244. As described above, in some embodiments, shutters do not flank the aperture and the filter.

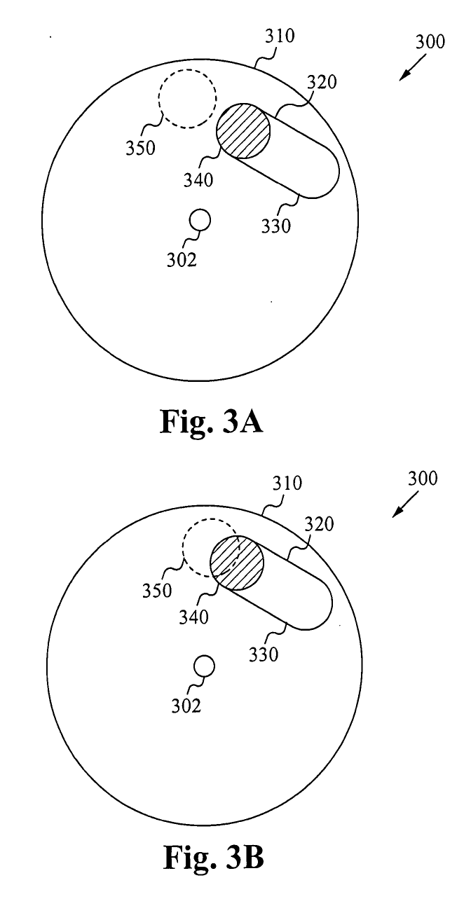

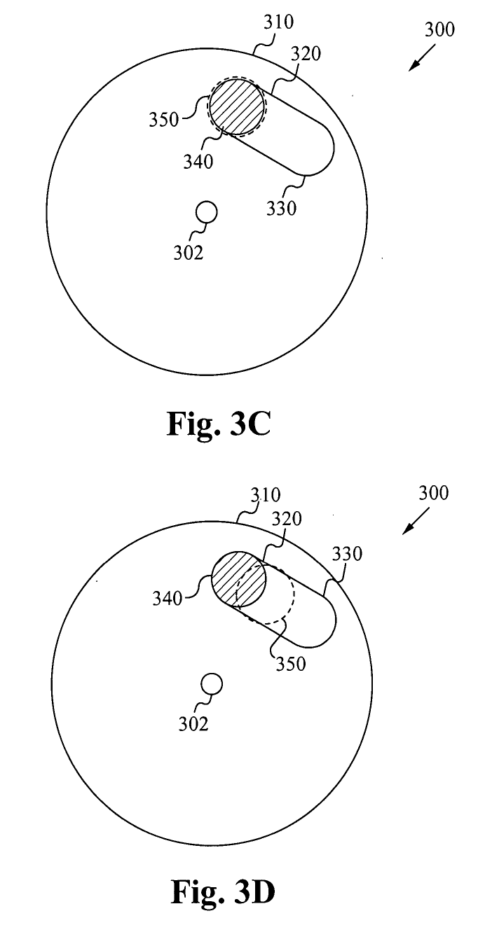

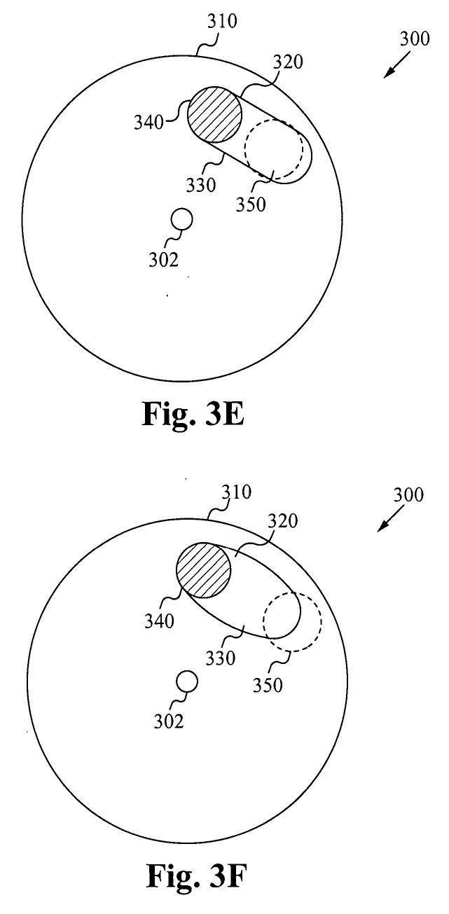

A number of possible configurations exist for movable filter module in order to achieve the selecting and mixing of light according to the objects of the present invention. FIGS. 3A-3F illustrate a rotatable disk configuration for the movable filter module 300 corresponding to the relative filter, aperture and shutter placements of FIGS. 1A-1F. In FIGS. 3A-3F, a disk 310 is centered around the axis 302. The embodiments shown in FIGS. 3A-3F include the rotatable disk 310, a slot 320 for holding a filter 340, and an aperture 330. The rotatable disk 310 is solid and acts like a shutter by blocking incident light. A light beam 350 is directed perpendicular to the rotatable disk 310. The rotatable filter module 300 is configured to filter, block or allow all or any portion of the light from a light source to pass therethrough.

FIG. 3A shows the rotatable filter module 300 with the light beam 350 completely blocked by the shutter (rotatable filter module 300). FIG. 3B shows the rotatable filter module 300 with the light beam 350 partially filtered by the filter 340 and partially blocked by the shutter (rotatable filter module 300). FIG. 3C shows the rotatable filter module 300 with the light beam 350 fully filtered by the filter 340. FIG. 3D shows the rotatable filter module 300 with the light beam 350 partially filtered by the filter 340 and partially passed through the aperture 330. FIG. 3E shows the rotatable filter module 300 with the light beam 350 completely passed through the aperture 330. FIG. 3F shows the rotatable filter module 300 with the light beam 350 partially passed through the aperture 330 and partially blocked by the shutter (rotatable filter module 300).

As explained above, the disk 310 is centered around the axis 320. The disk 310 is able to rotate about the axis 320. In some embodiments of the present invention, the rotation is mechanically controllable. In some embodiments of the present invention, the rotation is electronically controllable. Furthermore, in some embodiments, the rotation is both mechanically controllable and electronically controllable.

In the above FIGS. 3A-3F, the light which is allowed through the rotatable filter module 310, both filtered and full-spectrum light, is directed to a light guide (not shown) as illustrated in FIGS. 2A-2F. It will be readily apparent to those skilled in the art that the movable filter module 300 is able to take many shapes and sizes such that the amount of light being blocked, filtered light or full-spectrum light, is able to be allowed in any proportion. It will also be apparent that the light is able to be directed to a light guide either directly or as a result of optical focusing.

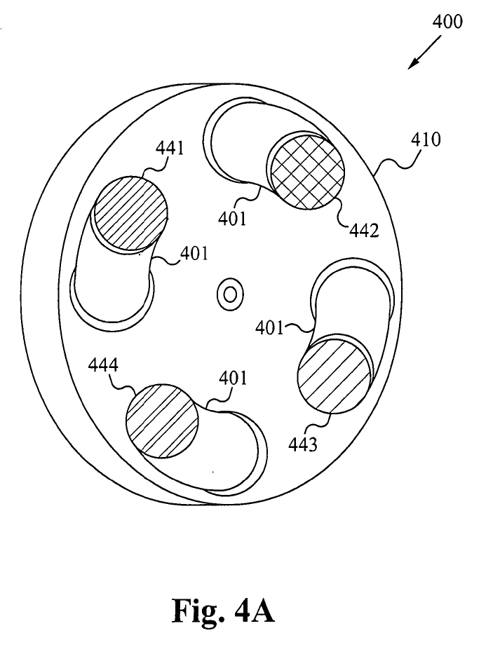

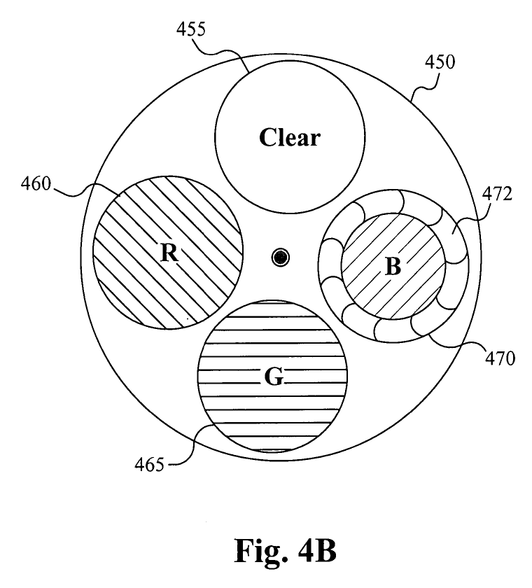

FIG. 4A illustrates another embodiment of the present invention in which a movable filter module 400 is a disk 410 with many openings 401 for multiple filters 441, 442, 443, 444. Preferably, the multiple filters 441, 442, 443, 444 are each chosen to filter wavelengths of light that correspond with the optimal excitation frequency of particular samples. In the manner described above with respect to the single filter modules, the multiple filter module 400 is configured to filter, block or allow all or any portion of the light from a light source to pass therethrough by positioning the appropriate filter 441, 442, 443, 444 and aperture 401 within the light beam.

In some embodiments of the present invention, a strobing disk 450 with multiple filters and shutters is used to filter light incident thereon. Within the strobing disk 450, multiple filters and apertures are able to be included in combinations appropriate for many different applications. As illustrated in the specific example of FIG. 4B, the rotatable strobing disk 450 includes a clear aperture 455, a red filter 460, a green filter 465 and a blue filter 470. In some embodiments, adjustable shutter mechanisms 472 are included over the aperture 455 and the filters 460, 465 and 470 for blocking all or a portion of the light incident thereon. In some embodiments, these adjustable shutter mechanisms 472 are either mechanical shutters or computer controlled LCD shutters for blocking part or all of the light through the appropriate aperture or filter. In other embodiments, the adjustable shutter mechanisms 472 are any appropriate shutter mechanism. The rotatable strobing disk 450 is rotated at a rotational speed such that the unshuttered portions of the aperture 455, the red filter 460, the green filter 465 and the blue filter 470 pass through the light beam on each revolution. In this manner, the light passing therethrough is mixed in the appropriate combination, as described above.

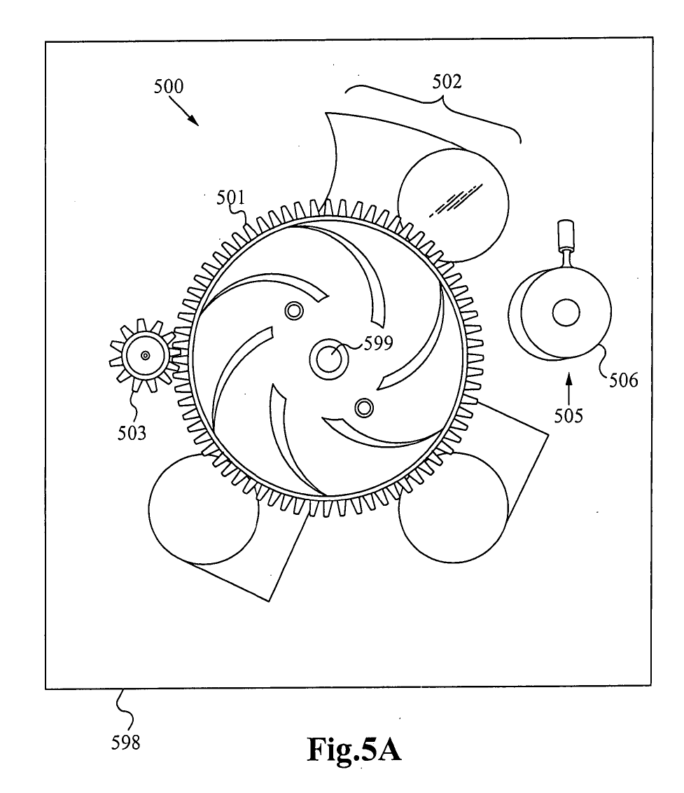

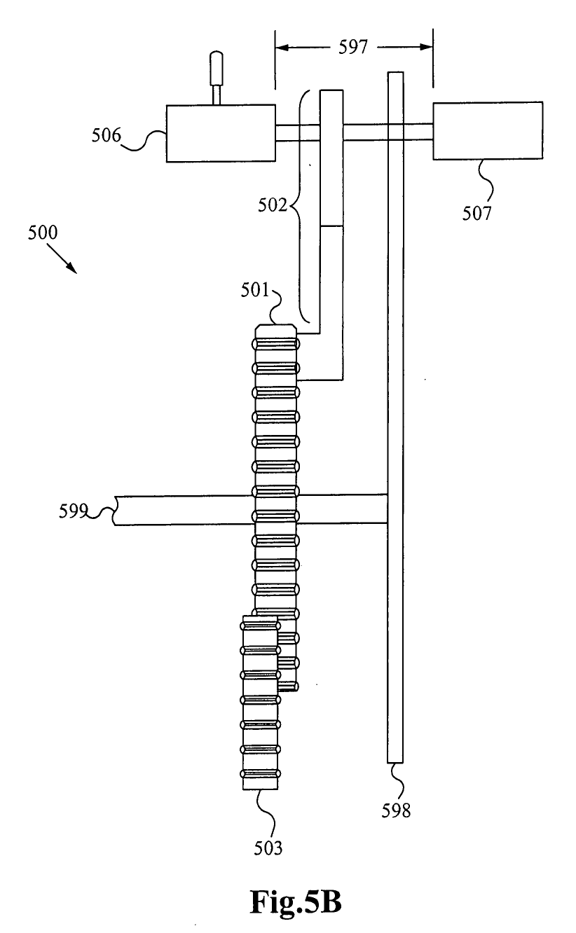

FIGS. 5A and 5B illustrate the filter module according to some embodiments of the present invention. FIG. 5A is a front view of the filter module 500 attached to the surface 598. In this example, the filter module comprises a geared disk 501 set on an axis 599. The geared disk is coupled with a number of translational filter, aperture and shutter attachments 502.

The geared disk 501 rotates about the axis 599 and is controllable by the rotation of the driving gear 503. In some embodiments of the present invention, the driving gear 503 is controlled mechanically. In other embodiments, the driving gear 503 is controlled electronically. In yet other embodiments of the present invention, the driving gear 503 is controllable both mechanically and electronically.

As the disk 501 rotates about the axis 599, the translational filter, aperture and shutter attachments 502 traverse through a light path (not shown) coming from the light guide 505. The light guide 505 guides light therethrough in the direction in and out of the page. The light guide 505 is held by a light guide holder 506. As shown in the side view of FIG. 5B, the light guide holder 506 is configured on one side of the surface 598 and the light guide holder 507 is configured on the other side of the surface 598. An air gap exists between planes of the light guide holder 506 and the light guide holder 507 such that the translational filter, aperture and shutter attachments 502 can pass therethrough. The angle of rotation of the disk 501 controls the position of the translational filter, aperture and shutter attachments 502 and therefor controls the proportions of light from the light guide that is filtered and blocked by the filter aperture and shutter attachments 502. FIG. 5B is a side view of the geared disk 501 and the light guide 505 according to some embodiments of the present invention.

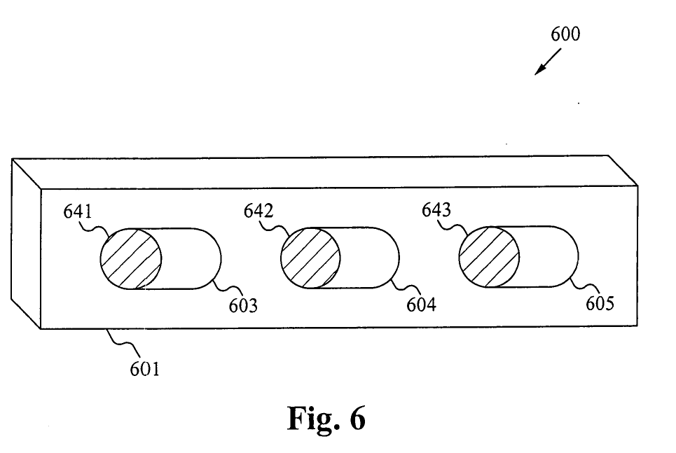

FIG. 6 illustrates the filter module according to some embodiments of the present invention in which the movable filter module 600 is a slide 601 with multiple openings 603, 604, 605 for filters 641, 642, 643. The slide 601 is configured to slide back and forth through a light path, wherein the position of the slide determines the proportions and strengths of filtered light and full-spectrum light which the slide allows through and the utilized filter determines the frequency of the filtered light.

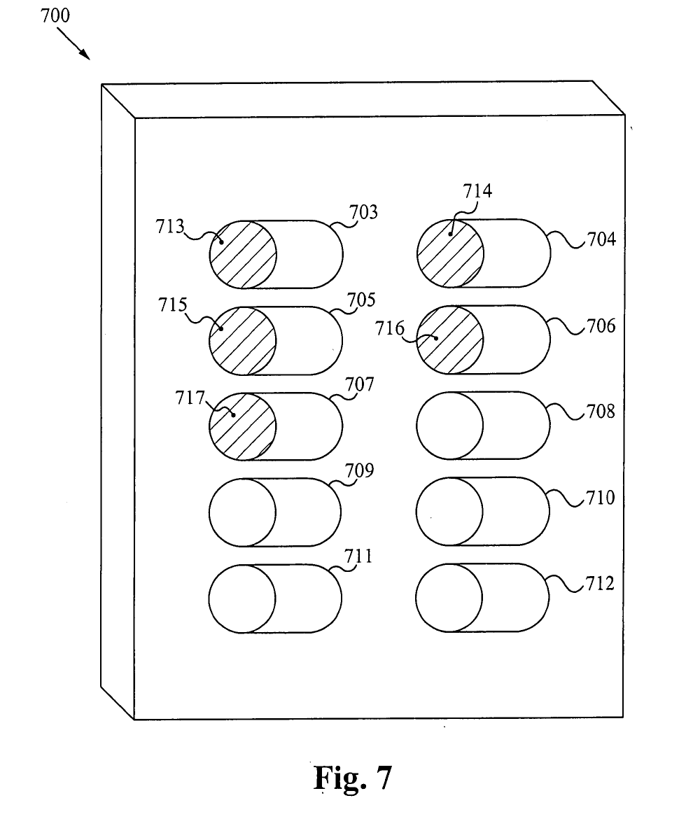

FIG. 7 illustrates some embodiments of the present invention in which the movable filter module 700 is a matrix of openings 703-712 that is movable on two axes. The openings are able to accommodate filters or are able to be left open. As shown in the exemplary configuration of FIG. 7, the openings 703-707 contain the filters 713-717, respectively. The filter module matrix 700 is configured to move left to right and up and down through a light beam, wherein the position of the slide determines the proportions and strengths of filtered light and full-spectrum light which the slide allows through and the utilized filter determines the frequency of the filtered light.

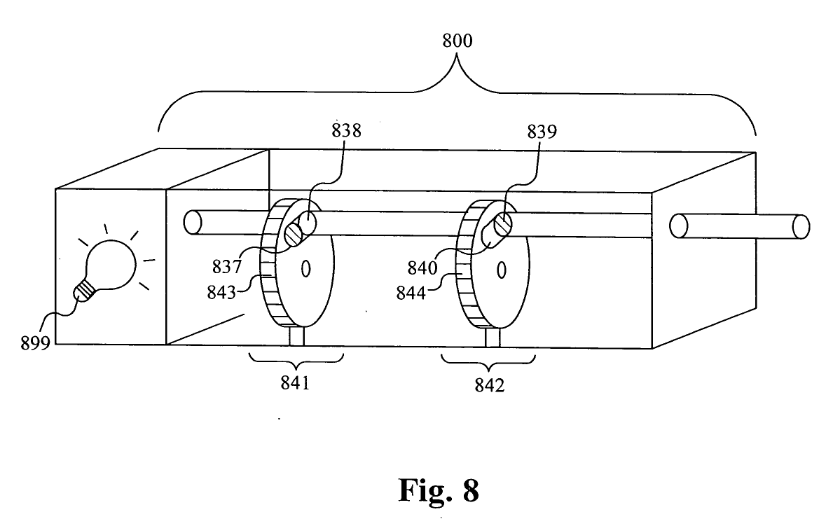

In some embodiments of the present invention, multiple, successively placed filters are used to achieve certain objects of the invention. FIG. 8 illustrates one particular setup with multiple filter modules 841, 842. In this particular embodiment, the filter module 841 comprises a rotatable disk 843 with a filter 837 and an aperture 838. A second filter module 842 comprises another rotatable disk 844 with a filter 839 and an aperture 840. The filter modules 841 and 842 are controlled to selectively filter the light beam, as described above. Only one filter is positioned incident to the light beam at any one time. As shown in the example of FIG. 8, the first filter module 841 is positioned so that the light beam passes through the aperture 838 and the second filter module 842 is positioned so that the light beam is filtered by the filter 839. In other embodiments, the first and second filter module 841 and 842 are selectively positioned entirely out of the light beam.

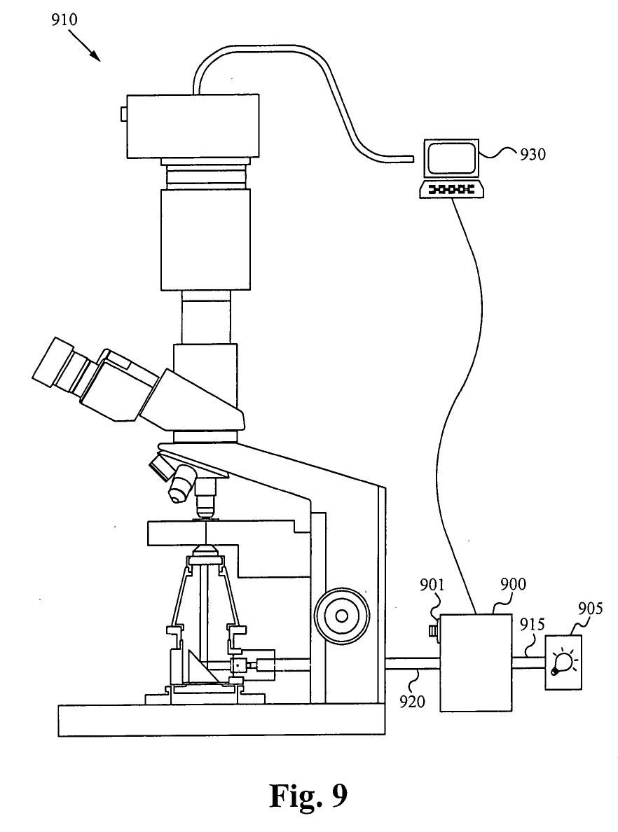

FIG. 9 illustrates the translational filter, aperture and shutter apparatus as a stand-alone module 900 according to some embodiments of the present invention. The module 900 is coupled between a light source 905 and a microscope 910. The light guide 915 delivers light from the light source 905 to the module 900 and the light guide 920 delivers light from the module 900 to the microscope 910. The guide and microscope may be replaced by any device benefitting from the mixture of light. In other embodiments, the module 900 might be incorporated into the device.

Preferably, the module 900 is able to be used as a component of existing commercial light sources and microscopes. In some embodiments of the present invention, the module is used with the microscope described in U.S. Pat. Nos. 6,992,819 and entitled “High-Resolution Optical Microscope For Quick Detection of Pathogens,” which is herein incorporated by reference.

In some embodiments of the present invention, the module is mechanically tuned with the knob 901. In some embodiments of the present invention, the module is tuned electronically. In some embodiments of the present invention, the module 900 is coupled to a computer 930. The computer 930 precisely controls how light is filter and proportioned by the module 900. In some embodiments of the present invention, the computer 930 is coupled to the microscope 910 for image capture and processing. In some embodiments of the present invention, a method of calibrating the module 900 depending on the sample to be observed by the microscope 910 is automated by the computer 930.

In some embodiments, the light source 905 is a high-intensity discharge (HID) lamp such as Ceramic discharge metal halide lamps, Hydrargyrum medium-arc iodide (HMI) lamps, Mercury-vapor lamps, Metal halide lamps, Sodium vapor lamps or Xenon arc lamps. However, it will be apparent to those skilled in the art that any light source is similarly envisioned.

The present invention provides numerous advantages to a number of applications which require a mixture of light. The present invention provides a means to mix a percentage of full-spectrum light and a percentage of light with selected wavelengths into a solid beam of light where the percentages, wavelengths and relative strengths are fine tunable. The relay system according to the present invention provides a continuous field of filtered light which provides uniform excitation of a sample. The translational filter, aperture and shutter of the present invention is able to be a stand-alone module which eliminates the need to buy an all new device. The module can be easily used with existing devices and light sources. Also, the present invention provides practitioners of microscopy and macroscopy the ability to observe a sample in real time by using a mixture of wavelengths.

With respect to microscopy and macroscopy, the present invention allows a user to produce real time images that include filtered and unfiltered components of a sample. The present invention eliminates the need to take multiple exposures at single wavelengths and full spectrum images, and computationally recombining them.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications can be made in the embodiment chosen for illustration without departing from the spirit and scope of the invention. Specifically, it will be apparent to one of ordinary skill in the art that the device and method of the present invention could be implemented in several different ways and have several different appearances.

What is claimed is:

1. An apparatus for filtering and mixing light comprising:
a filter; and
an aperture;
wherein the filter and aperture are configured to be selectively positioned incident to a light beam.

2. The apparatus for filtering and mixing light according to claim 1, further comprising a shutter configured to be selectively positioned incident to the light beam.

3. The apparatus for filtering and mixing light according to claim 2, wherein the filter, aperture and shutter are located on a filter module.

4. The apparatus for filtering and mixing light according to claim 3, wherein the filter module is moved mechanically.

5. The apparatus for filtering and mixing light according to claim 3, wherein the filter module is moved electronically.

6. The apparatus for filtering and mixing light according to claim 5, wherein an electronic movement of the movable filter module is controlled with a computer.

7. The apparatus for filtering and mixing light according to claim 2, wherein selective configuration of the filter, aperture and shutter results in a mixture of filtered and unfiltered light.

8. The apparatus for filtering and mixing light according to claim 1, further comprising a light guide positioned to receive the mixture of filtered and unfiltered light to mix light, thereby forming mixed light.

9. The apparatus for filtering and mixing light according to claim 1, further comprising a relay system comprising:
a collimator for collimating the light path, thereby forming collimated light which is directed selectively to the filter and aperture; and
a focusing lens following the filter and aperture, wherein light from the filter and aperture is focused by the focusing lens, thereby forming focused proportional light.

10. The apparatus for filtering and mixing light according to claim 9, further comprising a light guide positioned to receive the focused proportional light.

11. The apparatus for filtering and mixing light according to claim 10, wherein the light guide is configured to provide the focused proportional light to a device.

12. The apparatus for filtering and mixing light according to claim 11, wherein the device is selected from the group consisting of a microscope and a macroscope.

13. The apparatus for filtering and mixing light according to claim 3, wherein the filter module comprises more than one filter and more than one aperture.

14. The apparatus for filtering and mixing light according to claim 3, wherein the filter module comprises a rotatable disk.

15. The apparatus for filtering and mixing light according to claim 3, wherein the filter module comprises a slide on a rest, wherein the filter, aperture and shutter move as the slide moves on the rest.

16. The apparatus for filtering and mixing light according to claim 3, wherein the filter module comprises a matrix comprising multiple filters and apertures configured such that each filter and aperture is able to be selectively positioned incident to the light beam.

17. The apparatus for filtering and mixing light according to claim 3, further comprising at least one additional filter module configured to be placed serially in the light beam to further filter and block the light beam.

18. The apparatus for filtering and mixing light according to claim 1, wherein the light beam is moved relative to the filter and aperture.

19. An apparatus for filtering and mixing light comprising:
a light source forming a light path; and
a filter module comprising:
at least one filter to filter a portion of the light path, thereby forming a portion of filtered light;
at least one aperture to allow all components of a portion of the light path passage therethrough, thereby forming a portion of unfiltered light; and
at least one opaque surface on the filter module, wherein the opaque surface decreases the energy intensity of the light path by blocking a portion of the light path, thereby forming a portion of blocked light, wherein the portion of blocked light, the portion of filtered light and the portion of unfiltered light changes as a position of the filter module changes relative to the light path.

20. The apparatus for filtering and mixing light according to claim 19, further comprising a computer to control the position of the filter module.

21. The apparatus for filtering and mixing light according to claim 19, wherein the filter module comprises more than one slot and more than one opening.

22. The apparatus for filtering and mixing light according to claim 19, wherein the filter module comprises a rotatable disk.

23. The apparatus for filtering and mixing light according to claim 19, wherein the filter module comprises a slide on a rest, wherein the at least one filter, the at least one aperture and the at least one opaque surface move as the slide moves on the rest.

24. The apparatus for filtering and mixing light according to claim 19, wherein the filter module comprises a matrix comprising multiple filters and apertures configured such that each filter and aperture is able to be selectively positioned in the light path.

25. The apparatus for filtering and mixing light according to claim 19, wherein the light path is moved relative to the filter module.

26. An apparatus for relaying, filtering and mixing light comprising:
a light source forming a light path;
a collimator for collimating the light path, thereby forming collimated light;
a filter module configured to receive the collimated light, the filter module comprising:
at least one filter to filter a portion of the collimated light path, thereby forming a portion of filtered light;
at least one aperture to allow all components of a portion of the collimated light path passage therethrough, thereby forming a portion of unfiltered light; and
at least one opaque surface on the filter module to decrease the energy intensity of the collimated light path by blocking a portion of the collimated light path, thereby forming a portion of blocked light, wherein the portion of blocked light, the portion of filtered light and the portion of unfiltered light changes as the filter module moves through the collimated light; and
a focusing lens following the filter module, wherein the portion of filtered light and the portion of unfiltered light is focused by the focusing lens, thereby forming focused proportional light.

27. The apparatus for relaying, filtering and mixing light according to claim 26, further comprising a light guide positioned to receive the focused proportional light.

28. A method of mixing light comprising:
forming a light path from a light source;
placing at least one filter module in the light path, the filter module comprising:
at least one filter to filter a portion of the light path, thereby forming a portion of filtered light;
at least one aperture to allow all components of a portion of the light path passage therethrough, thereby forming a portion of unfiltered light; and
at least one opaque surface on the at least one filter module, wherein the opaque surface decreases the energy intensity of the light path by blocking a portion of the light path, thereby forming a portion of blocked light; and
positioning the at least one filter module such that a desired amount of light is filtered, such that a desired amount of light is blocked by the opaque surface, and such that a desired amount of light is allowed to pass through the aperture freely, thereby forming resultant light.

29. The method for mixing light according to claim 28, wherein the position of the at least one filter module is controlled mechanically.

30. The method for mixing light according to claim 28, wherein the position of the at least one filter module is controlled electronically.

31. The method for mixing light according to claim 28, further comprising directing the resultant light to a light guide to mix the resultant light.

32. The method for mixing light according to claim 28, further comprising:
collimating the light path from the light source with a collimator; and
focusing the resultant light with a focusing lens.

33. The method for mixing light according to claim 32, wherein the focusing lens focuses the resultant light to a diameter of a light guide.

34. An apparatus for filtering and mixing light comprising:
a first rotatable disk comprising a first filter and a first aperture; and
a second rotatable disk comprising a second filter and a second aperture;
wherein a relative speed of the first rotatable disk and the second rotatable disk is varied such that when a light beam passes though the first rotatable disk and the second rotatable disk, a strobing effect is created.

35. The apparatus for filtering and mixing light according to claim 34 wherein the first rotatable disk comprises a second filter.
